(19) United States
(12) Patent Application Publication
(10) Pub. No.: US 2024/0409279 A1
(43) Pub. Date: Dec. 12, 2024

(54) WHEELED CONTAINER ASSEMBLY

(71) Applicant: KETER HOME AND GARDEN PRODUCTS LTD, Herzliya (IL)

(72) Inventors: Yaron BRUNNER, Kibbutz Gvat (IL); Uri PARIZER, Kibbutz Hukok (IL); Ayala VARDI-BOUGAY, Kefar Veradim (IL)

(73) Assignee: KETER HOME AND GARDEN PRODUCTS LTD, Herzliya (IL)

(21) Appl. No.: 18/699,838

(22) PCT Filed: Oct. 6, 2022
(86) PCT No.: PCT/IL2022/051060

§ 371 Date: Apr. 9, 2024

Related U.S. Application Data
(60) Provisional application No. 63/262,369, filed on Oct. 11, 2021.

(51) Int. Cl. B65D 43/20; B62B 1/12; B62B 5/06; B65D 25/24; B65D 25/28; B65D 43/22

(52) U.S. Cl. CPC B65D 43/20; B62B 1/12; B62B 5/067; B65D 25/24; B65D 25/282; B65D 43/22; B65D 2525/287; B65D 2543/00175

(57) ABSTRACT

A container assembly comprising a base container configured with a top opening and closeable by a slidable lid, wherein the slidable lid is configured with an articulation arrangement for detachably articulating thereto at least one utility module, and wherein said lid is configured with a wheeled handle assembly for locomoting the container assembly.

### TECHNOLOGICAL FIELD

The present disclosure is concerned with a wheeled container assembly.

The term container as used herein throughout the specification and claims denotes any form as containers, such as, toolboxes, utility storage units, utility modules and tools, shopping carts, suitcases and the like.

### BACKGROUND ART

References considered to be relevant as background to the presently disclosed subject matter are listed below:
U.S. Pat. No. 7,938,412
U.S. Pat. No. 8,132,819
US2010052276
WO14125484

Acknowledgement of the above references herein is not to be inferred as meaning that these are in any way relevant to the patentability of the presently disclosed subject matter.

### BACKGROUND

U.S. Pat. No. 7,938,412 discloses a container assembly is provided that includes a base container that has an upper opening and an upper container mounted in covering relation over the upper opening of the base container. A linkage connects the upper container to the base container in a manner that allows the upper container to be displaced from the covering relation over the upper opening of the base container, so as to permit access into the base container through the upper opening. A support assembly is spaced from the base container when the upper container is displaced from the covering relation over the upper opening of the base container and wheels are disposed toward a lower portion of the container assembly. A handle is provided for rollingly transporting the container assembly on the wheels in a tilted configuration.

U.S. Pat. No. 8,132,819 discloses a rolling container assembly includes a base container, wheels to provide rolling support, at least one removable container, and a container engaging region with an automatic lock interacting between the removable container and the container engaging region. The automatic lock is releasable so that the removable container can be released to enable the at least one removable container to be carried by its carrying handle and transported separately from the base container. The assembly has a lower drawer and an upper drawer, and a slide structure having a first portion mounted to the upper drawer and a second portion mounted to the lower drawer to facilitate movement of the drawers. The lower drawer and upper drawer are independently movable between their respective open and closed positions. The apparatus includes a central frame structure carrying a lock member that enables the upper drawer to be locked in the closed position.

US2010052276 discloses a portable containers assembly comprising a base cabinet in the form of a bucket having an upper end and a top case assembly comprising at least one top cabinet. The top cabinet is slidably secured to the base cabinet. The top cabinet is slidable between a closed position in which it substantially covers the upper end of the base cabinet, and an open position in which it exposes the base cabinet. The portable containers assembly further comprising a locomotive assembly having a wheeling assembly and a handle assembly for locomoting the portable containers assembly.

WO14125484 discloses a toolbox comprising: a base member having base walls defining a base interior space; and a cover member having cover walls, said cover member being articulated to the base member by an articulation mechanism, the cover member being displaceable between a closed position in which the cover member extends over the base member, and an open position in which the cover member is displaced with respect to the base member so as to allow access to the base interior space. The cover member has at least one cover engagement element associated with at least one of the cover walls, and the base member having at least one base engagement element associated with at least one respective base wall and configured, in the closed position of the cover member, to engage the cover engagement element for arresting the cover member to the base member, so as to establish engagement between the cover member and the base member for transmitting between the cover member and the base member internal forces generated by external forces applied on at least one member of the toolbox, thereby substantially reducing or eliminating transmission of internal forces to the articulation mechanism.

### GENERAL DESCRIPTION

According to the present disclosure there is provided a container assembly comprising a base container configured with a top opening and closeable by a slidable lid, wherein the slidable lid is configured with an articulation arrangement for detachably articulating thereto at least one utility module, and wherein said lid is configured with a wheeled handle assembly for locomoting the container assembly.

The term utility module as used herein throughout the specification and claims denotes any form and usage of utility items, such as containers (of any type, size, shape), toolboxes, utility storage units, utility modules and tools, power tools, machines, etc.

A transportable container assembly comprising a base container configured with upright extending side walls defining a top opening of the base container, a slidable lid is slidingly displaceable over the top opening of the base container between a closed position wherein the lid coextends over and covers the top opening, and an open position wherein the lid is displaced backwards and exposes the base container to allow access thereto; wherein the is configured with an articulation arrangement for detachably articulating thereto at least one utility module, and wherein a back portion of the lid is configured with a handle assembly and a locomotive arrangement for locomoting the container assembly at the closed position.

According to a particular configuration of the disclosure, the handle assembly is a telescopic handle manipulable between a collapsed position and at least one retracted position, and the locomotive arrangement is a wheel assembly disposed at a bottom portion of the handle assembly, and wherein the container assembly can be locomoted over the wheel assembly by tilting the container assembly backwards.

The wheel assembly comprises at least a pair of wheels wherein a tangent of the wheels is leveled with a bottom face of the base container.

The wheels are disposed at a fixed elevation, wherein when the container assembly is positioned over a flat support surface, displacing the slidable lid into its open position entails rolling displacement of the wheels over a ground surface.

Any one or more of the following features, designs and configuration can be applied to any one or more of the aspects and embodiments of the container assembly subject of the present disclosure, separately or in various combinations thereof:
A roll axis of the wheels can extend below bottom ends of legs of the handle assembly;
A roll axis of the wheels can extend between a back face of the base container and the front face of the handle assembly;
An axle of the wheels can be articulated to an axle support member inwardly extending from a bottom portion of legs of the telescopic handle; according to a particular example the wheels axle is supported by two support members, each extending at a bottom of a respective leg of the handle assembly;
An axle of the wheels can be articulated to a non-displaceable bottom support segment of the handle assembly, thereby retaining the wheels at a fixed elevation;
At the closed position of the slidable lid, the axle of the wheels can extend within a niche disposed before the back wall of the base container, i.e. between the front wall and the back wall of the base container;
The handle assembly can extend through a back portion of the slidable lid, wherein at the closed position of the slidable lid said back portion is disposed behind a back wall of the base container;
At the closed position of the slidable lid, said axle support member is received within a wheel axle support indention formed at a rear face of the base container;
At the closed position of the slidable lid, a bottom face portion of the wheel axle support indention of the base container bears over a top face of said axle support members;
At a fully open position a front edge of the slidable lid extends over at least a portion of a back, top edge of the base container;
At the closed position a front edge of the slidable lid extends over at least a portion of a front, top edge of the base container;
The handle assembly is a telescopic handle assembly, wherein at a retracted position of the telescopic handle a bottommost end thereof can extend below the wheel's axle and above the bottom face of the base container;
The slidable lid can be configured at a back end thereof with a downwardly extending portion, wherein at the closed position of the slidable lid a front face of said downwardly extending portion can extend behind a rear face of a rear top edge of the base container;
The top face of the slidable lid can be configured with a depressed utility module receiving portion;
At the fully closed position of the slidable lid, a portion of the wheels can be received within depressions configured at respective side walls of the base container;
At a fully open position of the slidable lid, a bottom face of a front edge of the slidable lid can bare over a top back edge of the base container;
The bottom face of a front edge of the slidable lid can be configured with a base container seat for receiving top back edge of the base container at the fully open position of the slidable lid;
The base container can be rectangle;
The container assembly can further comprise a lid locking mechanism, for arresting the slidable lid and preventing sliding displacement at least when at the closed position;
The lid locking mechanism can be a locking latch extending at a front face of either the base container or the slidable lid;
The lid locking mechanism can be configured for spontaneously arresting the slidable lid when displaced into its closed position;
The lid locking mechanism can be a latch normally disposed at an arresting position, wherein one or both of the locking latch of the lid locking mechanism and a latch arresting notch can be configured with a chamfered portion for momentarily displacing latch into an open position when the slidable lid is displaced into its closed position;
The lid locking mechanism can be any one or more of side locking latches, back locking latch, rotary locking latch, snap locking latch, manually operable locking latches, etc.;
The base container can be configured with a wheeling system for rolling the container at an upright position over the base container;
A utility module can be attached over the top face of the slidable lid, or detached therefrom, regardless of the position of the slidable lid;
At the retracted position of the telescopic handle, a handle portion can extend above a top surface of the slidable lid;
A manipulating mechanism of the telescopic handle and the handle portion are spaced from a back wall surface of the base container;
A utility module can be attached over the top face of the slidable lid, or detached therefrom, regardless of the position of the telescopic handle;
The slidable lid is slidably articulated over the base container by a rail mechanism disposed at respective side ends of the base container and slidable lid;
The rail mechanism can be a telescopic rail set, comprising a first rail member articulated at a top portion of the base container, and a second rail member articulated at a bottom portion of the slidable lid, wherein the first rail member and the second rail member are engaged with one another and configured for sliding displacement with respect to one another;
The first rail member and the second rail member can be configured for reduced sliding friction therebetween. For example, a bearing set can be configured between the rails;
The first rail member can be secured at an inside top side edges of the base container, and the second rail member can be configured at an outside-facing wall portion of the slidable lid, respectively;
The either or both of the base container and the slidable lid can comprise a sliding restricting arrangement, configured for restricted sliding displacement of the sliding lid between a fully open position and a closed position thereof;
A base of the at least one utility module can occupy the entire top face of the slidable lid;
A base of the at least one utility module can occupy only a portion of the top face of the slidable lid;
The articulation arrangement can be configured at a top face of the slidable lid;
The articulation arrangement can be configured at any location of the of the slidable lid; the articulation arrangement can be configured either or both side portions of the slidable lid, and/or the articulation arrangement can be disposed at either or both back and front portions of the slidable lid;
The articulation arrangement can be configured for attaching a utility module having a smaller footprint than that of the slidable lid;
The articulation arrangement can be of any form and type;
According to one example, articulation arrangement comprises at least one locking member pivotally secured to the slidable lid, and the utility module is configured with a locking receptacle; wherein the locking member is configured with at least one locking latch configurable for locking engagement within said locking receptacle; and wherein the locking member is pivotally displaceable between a locked position in which the at least one locking latch is radially engaged within the locking receptacle, and an unlocked position in which the locking member is outwardly pivoted and the at least one locking latch is disengaged from the locking receptacle;
According to another example, the articulation arrangement comprises a sliding locking mechanism, wherein the slidable lid is configured with a first locking member and the utility module is configured at a bottom portion thereof with a second locking member; such that when the utility module rests over the slidable lid, said first locking member and said second locking members are aligned and are configured for lockingly interacting with one another;
According to yet an example, the articulation arrangement comprises a pair of pivoting latch members, each disposed near an opposite end of the slidable lid, and the utility module is configured at a bottom portion thereof with a pair of spaced apart locking retaining members for detachable articulation with the pivoting latch members of the slidable lid; wherein the slidable lid is configured with a top bearing face and said utility module is configured with a bottom bearing face, whereby the pivoting latch members can be arrested by the locking retaining members when the bottom bearing face bears over the top bearing face.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a front, right side perspective view of a container assembly according to an example of the present disclosure;

FIG. 1B is a rear perspective view of the container assembly of FIG. 1A;

FIG. 1C is a planar side view of the container assembly of FIG. 1A;

FIG. 2A is a section taken along line 2A-2A in FIG. 1A;

FIG. 2B is an enlargement of the portion marked 2B in FIG. 2A;

FIG. 2C is an enlargement of the portion marked 2C in FIG. 2A;

FIG. 3A is a section taken along line 3A-3A in FIG. 1A;

FIG. 3B is an enlargement of the portion marked 3B in FIG. 3A;

FIG. 4A is a section taken along line 4A-4A in FIG. 1A;

FIG. 4B is an enlargement of the portion marked 4B in FIG. 1A, illustrating an example of an articulation arrangement, at an unlocked position;

FIG. 4C is a section taken along line 4C-4C in FIG. 4B;

FIG. 4D is a section taken along line 4D-4D in FIG. 4B;

FIG. 5A is a front, left side perspective view of the container assembly of FIG. 1A;

FIG. 5B is a section taken along line 5B-5B in FIG. 5A;

FIG. 5C is an enlargement of the portion marked 5C in FIG. 5A;

FIG. 5D is an enlargement of the portion marked 5D in FIG. 5B;

FIG. 5E is a section taken along line 5E-5E in FIG. 5C;

FIG. 6A is a front, right side perspective view of the container assembly of FIG. 1A, with the slidable lid at an open position and the handle assembly at a retracted position;

FIG. 6B is a planar side view of the container assembly of FIG. 6A;

FIG. 6C is a section taken along line 6C-6C in FIG. 6A;

FIG. 7A is an enlargement of the portion marked 7A in FIG. 6C;

FIG. 7B is an enlargement of the portion marked 7B in FIG. 6C;

FIG. 8A front, right side perspective view of the container assembly subject of the present disclosure, with a utility module articulated over the closed slidable lid, and the handle assembly at a retracted position, and the articulation arrangement at an unlocked position;

FIG. 8B is a section taken along line 8B-8B in FIG. 8A;

FIG. 8C is an enlargement of the portion marked 8C in FIG. 8B;

FIG. 8D is a planar view of the enlarged portion of 8C;

FIG. 9A front, left-side perspective view of the container assembly subject of the present disclosure, with a utility module articulated over the closed slidable lid, the handle assembly at a retracted position, and the articulation arrangement at a locked position;

FIG. 9B is an enlarged, planar section, taken along line 9B-98B in FIG. 9A;

FIG. 9C is an enlarged section, taken along line 9B-98B in FIG. 9A;

FIG. 10A is a section taken along line 10A-10A in FIG. 8A;

FIG. 10B is an enlargement of the portion marked 10B in FIG. 10A;

FIG. 10C is an enlargement of the portion marked 10C in FIG. 10A;

FIG. 11A front, right side perspective view of the container assembly subject of the present disclosure, with a utility module articulated over the fully open slidable lid, and the handle assembly at a retracted position, and the articulation arrangement at an unlocked position;

FIG. 11B is a planar side view of FIG. 11A;

FIG. 12A is a front, right-side perspective view of a container assembly according to another example of the present disclosure, configured with a different articulation arrangement;

FIG. 12B is a rear right-side perspective view of the container assembly of FIG. 12A, with a utility module articulately mounted thereover;

FIG. 12C is a perspective view of a utility module articulable with a container assembly according to the example of FIGS. 12A and 12B;

FIG. 13A is a front, left-side perspective view of a container assembly according to another example of the present disclosure, configured with still a different articulation arrangement;

FIG. 13B is a top, local portion, of the articulation arrangement over the slidable lid;

FIG. 13C is a top perspective view of a utility module articulable with the container assembly of FIG. 13B (a top face thereof mimicking a top face of the slidable lid); and

FIG. 13D is a bottom perspective view of the utility module of FIG. 13C.

### DETAILED DESCRIPTION OF EMBODIMENTS

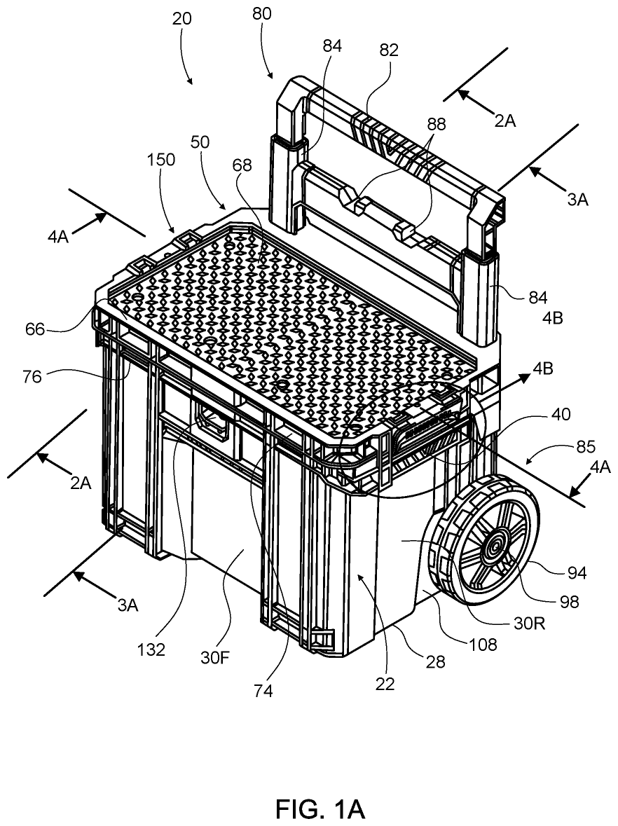

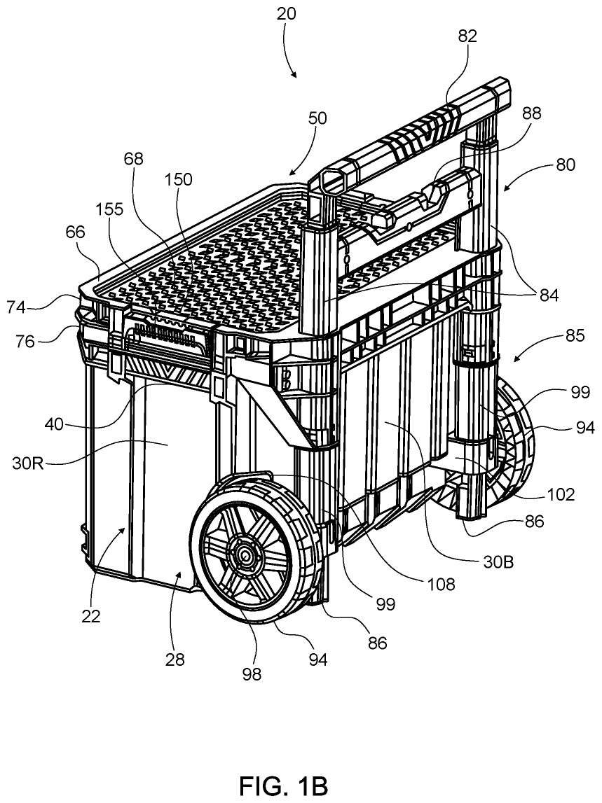

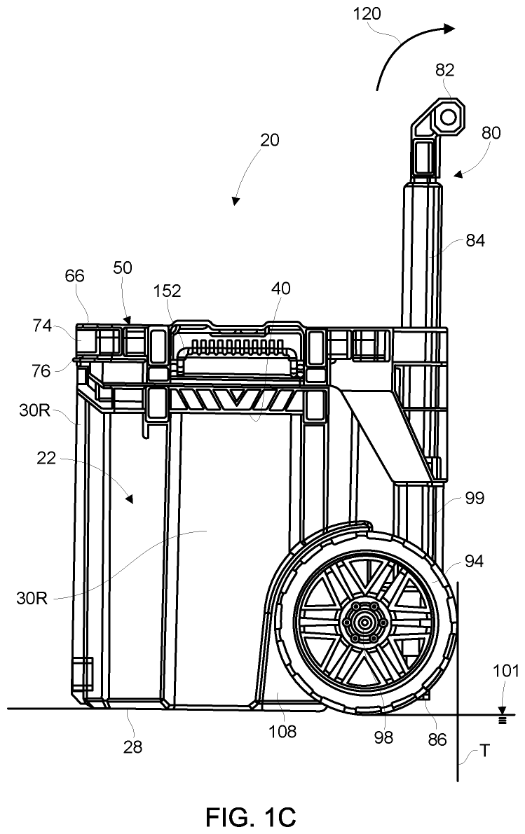

Attention is first directed to FIGS. 1A to 7B of the drawings, concerned with a transportable container assembly according to an example of the present disclosure, generally designated 20. The container assembly 20 comprises a base container generally designated 22 in the form of a rectangular, open top container (‘bucket-like’). Base container 22 comprises a base 28 with four side walls upright extending therefrom, namely a front wall 30F, a back wall 30B, a right-side wall 30R and a left side wall 30R, wherein said side walls define together a top edge 34 with a top opening into an inside space 36 of the base container 22. It is seen that top edge 34 is substantially perimetric, and uninterrupted with the front and back top edge portions only slightly elevated with respect to side top edge portions.

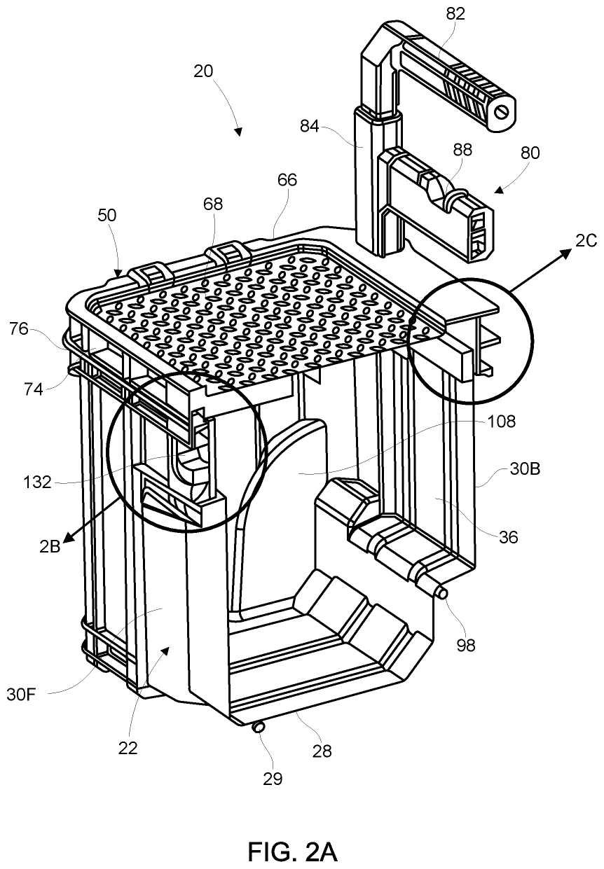

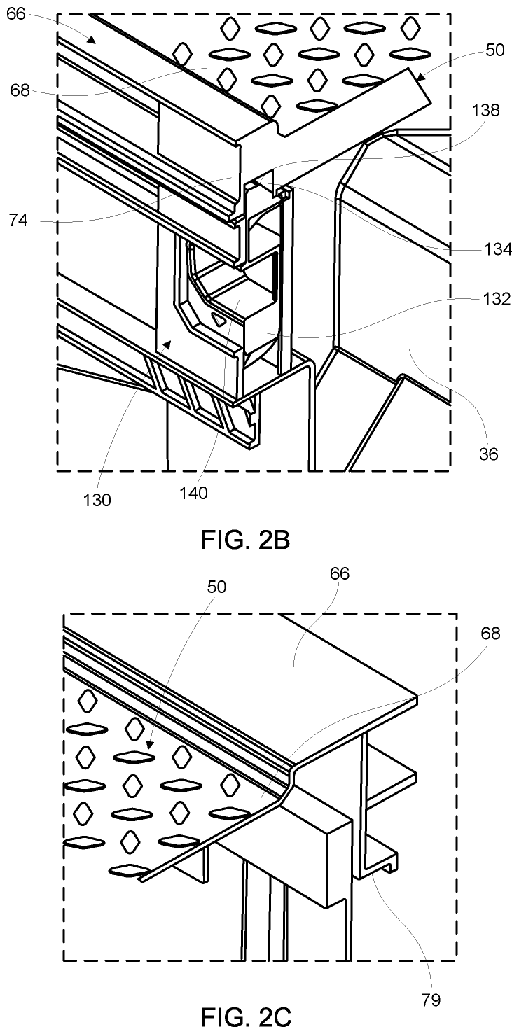

The base container 22 is a large container, made of rigid material, such as molded plastic material. The base 28 of the base container 22 is substantially flat, and according to a specific embodiment (exemplified in FIG. 2A) a bottom surface of base 28 can be configured with one or more caster ball wheels 29. The right-side wall 30R and the left side wall 30R are each configured with a gripping portion (handle) 40, which in the present example is integrally molded with the base container, though according to other examples (not shown), handles can be of other configuration, e.g. a pivot handle articulated with the side walls, etc.

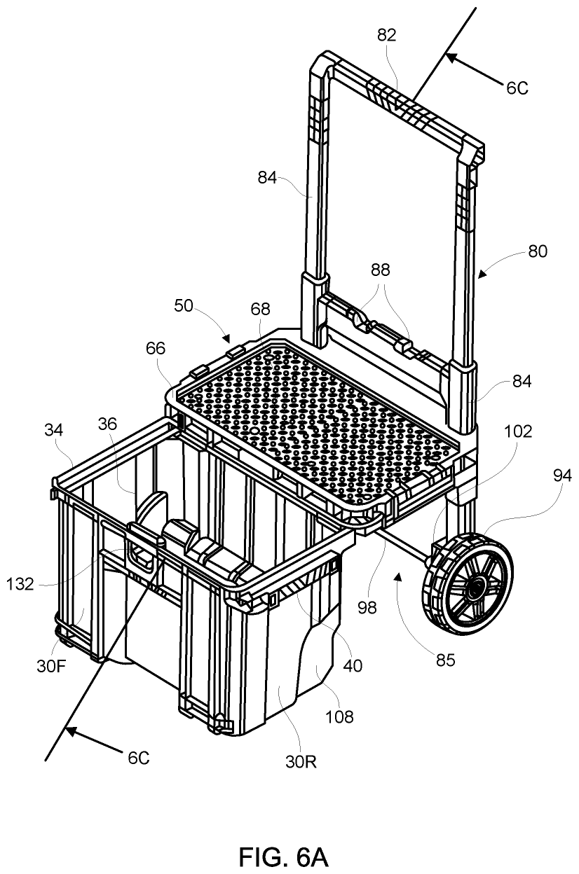

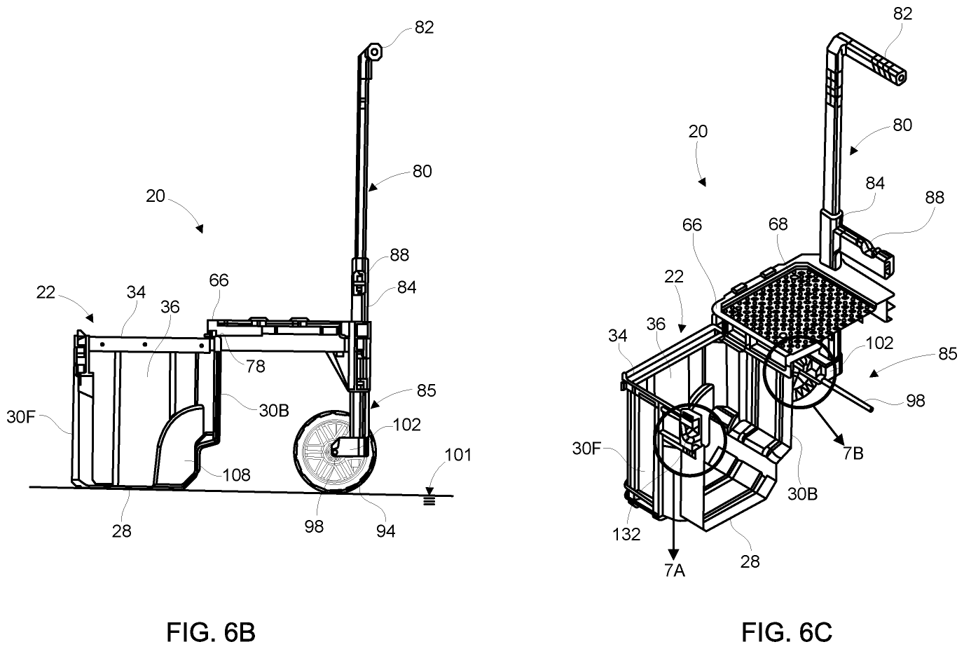

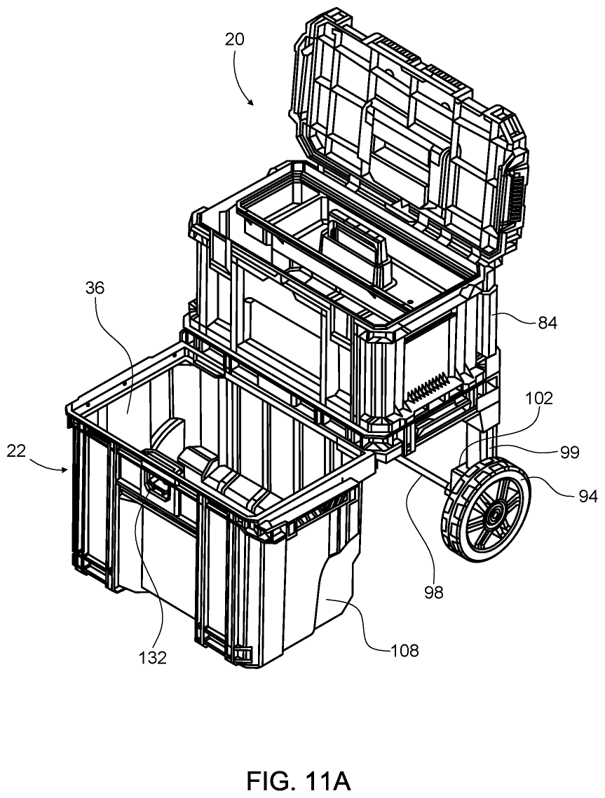

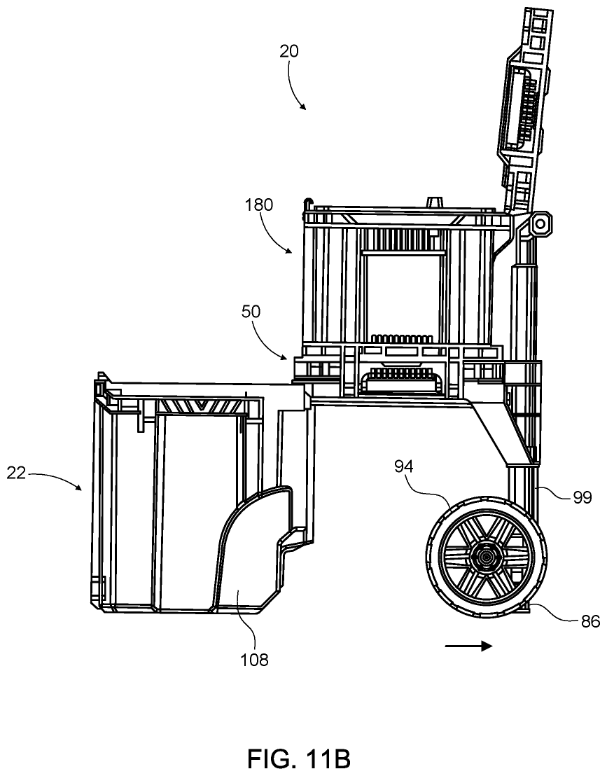

A slidable lid 50 is articulated to the base container 22 over top edge 34. The lid is slidably displaceable between a fully closed position (e.g. FIGS. 1A, 1B, 2A and 5A), at which access to the inside space 36 of the base container 22 is not possible, and a fully open position (e.g. FIGS. 6A, 6B, 6C and 11A) at which of the base container 22 is possible (though access to the inside space 36 can be possible at an intermediate open position of the lid; not shown).

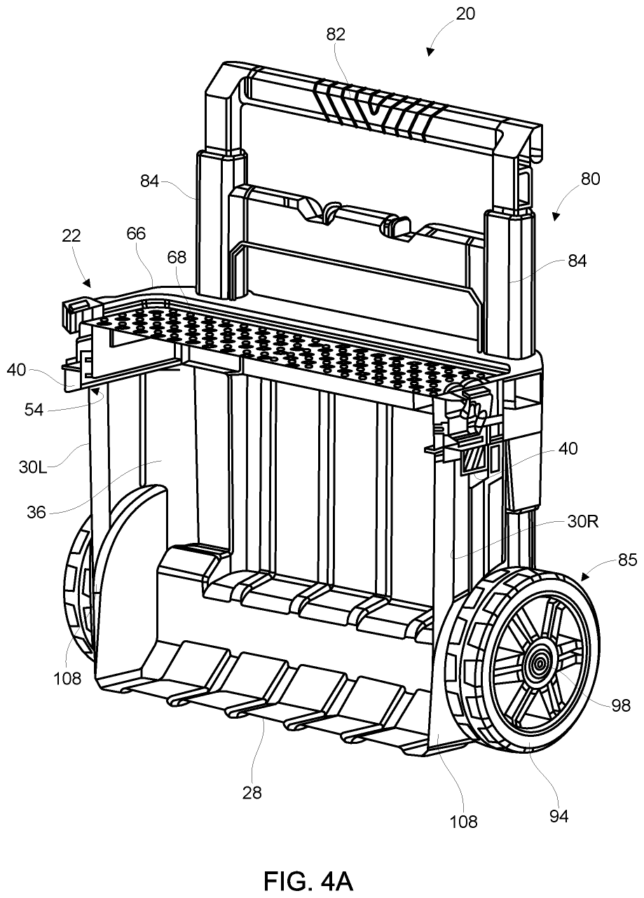

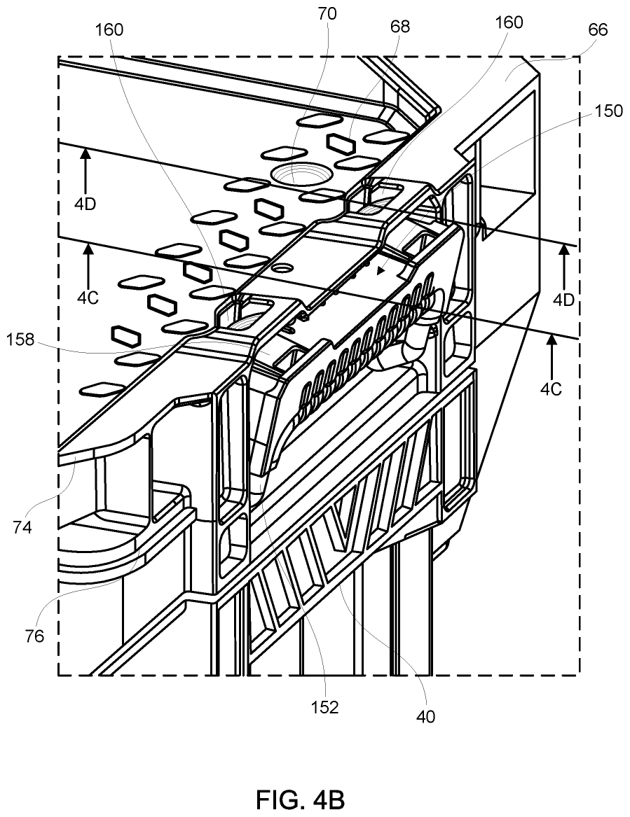

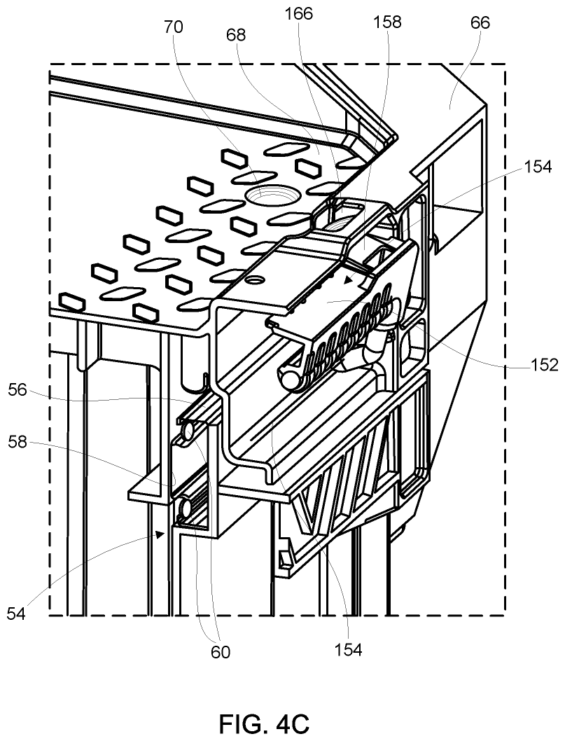

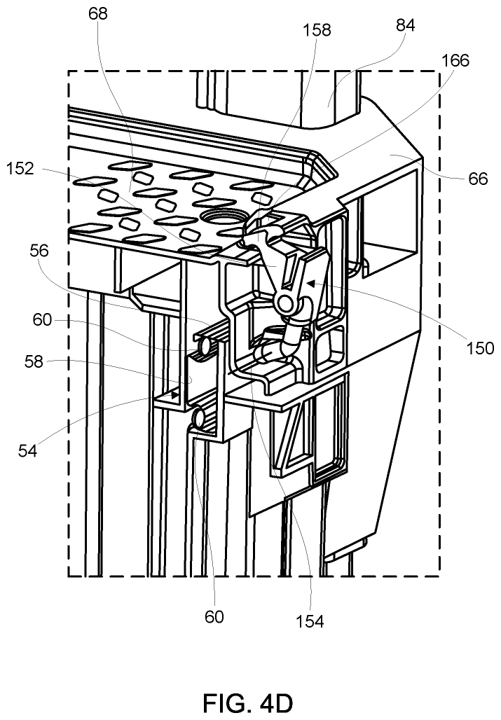

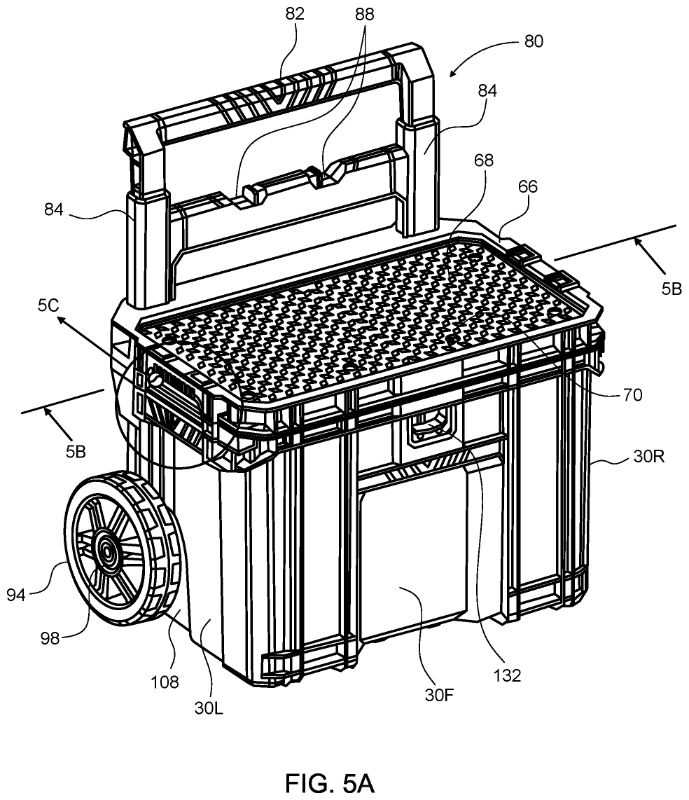

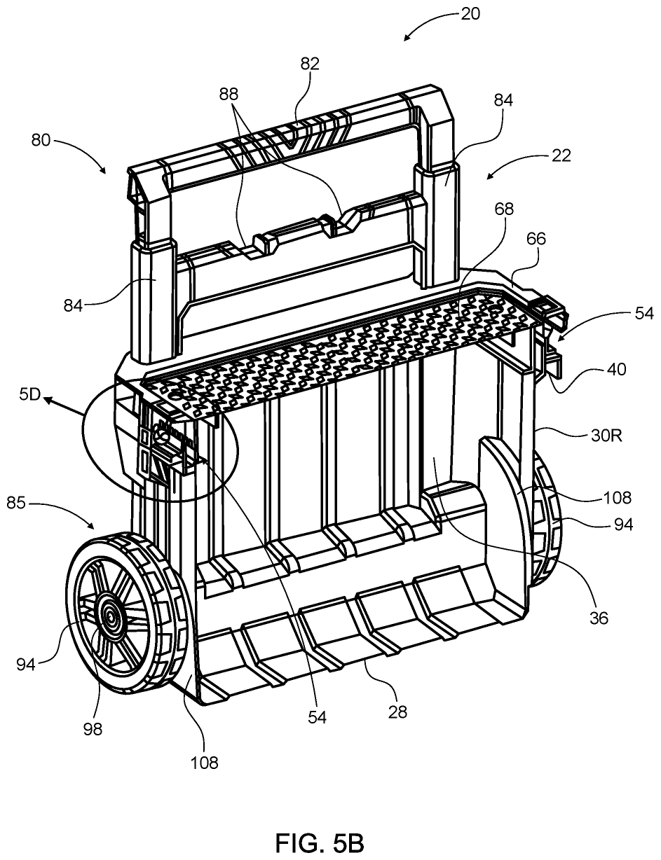

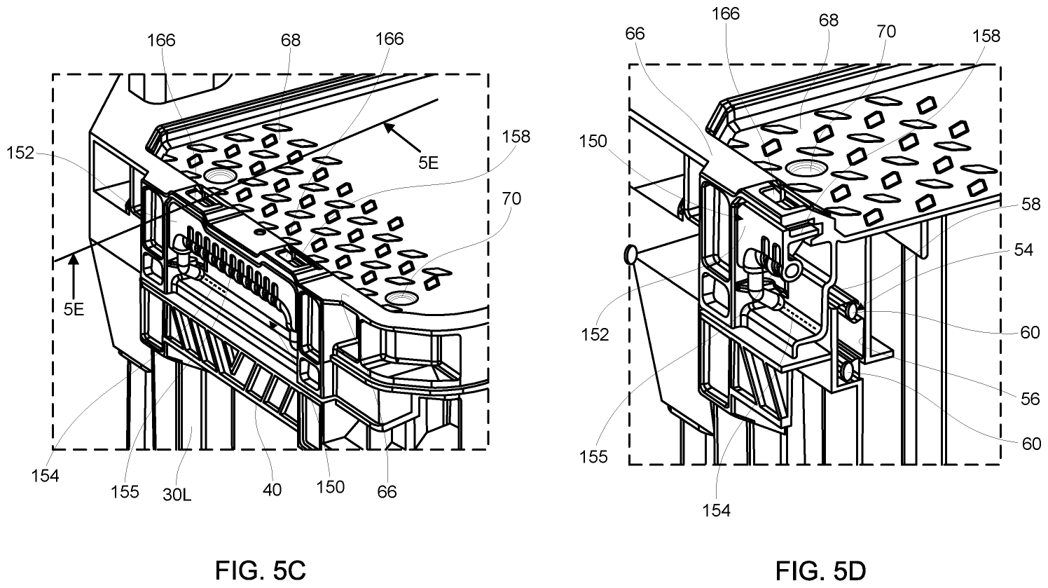

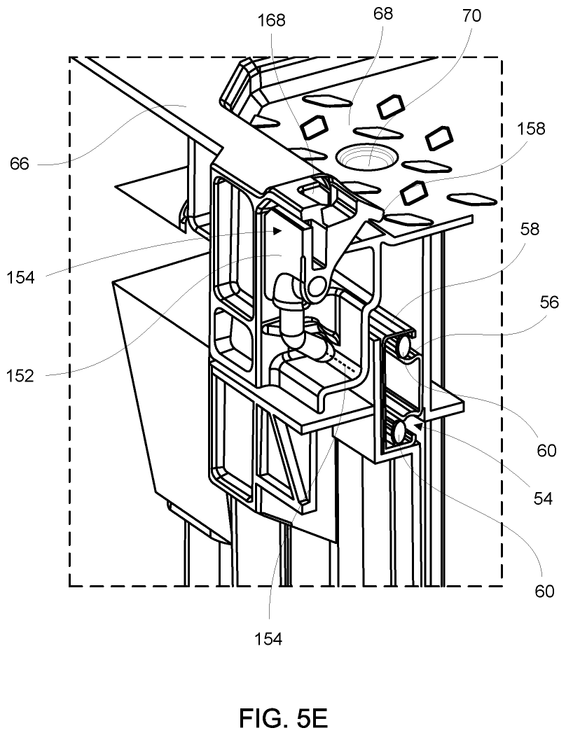

The slidable lid 50 is articulated to the base container 22 by a telescopic rail set mechanism 54 (best seen in FIGS. 4C, 4D, 5D and 5E) comprising a first rail member 56 articulated at a top, inside portion of the base container 22, and a second rail member 58 articulated at a bottom, inside portion of the slidable lid 50, wherein the first rail member and the second rail member are slidingly articulated with one another and configured to facilitate smooth sliding displacement of the slidable lid 50 over the a top edge 34 of base container 22, with a friction reducing wheel/bearing 60 disposed between the first rail member 56 and the second rail member 58.

The lid 50 is configured at a top face thereof with an annular rim 66 defining a depressed utility module receiving portion 68, having a diamond shaped anti-slip surface and comprising several threaded articulation locations 70.

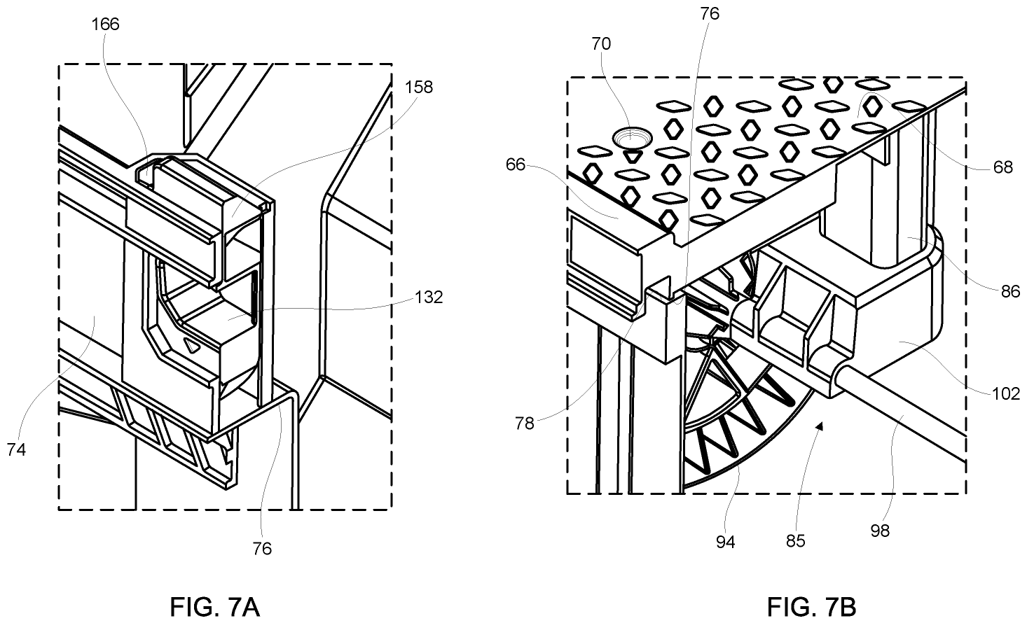

A front edge 74 of the slidable lid 50 is configured with a bottom edge 76 (best seen in FIG. 2B), wherein at the closed position of the slidable lid 50 said container bottom edge 76 extends in close proximity over a corresponding top front portion of edge 34 (FIG. 76), and wherein at the fully open position of the slidable lid 50, said container bottom edge 76 extends in close proximity over a top back edge 78 of the base container 22 (FIG. 7B), however wherein in fact the slidable lid is supported over the rail set mechanism 54, wherein the weight of said lid (and any utility module articulable thereto) is carried by the rail mechanism. It can be seen that at the closed position, side edges of the lid 50 overlap outside top side edges of the base container 22.

The slidable lid 50 is configured at a back side thereof with a downward extending skirt segment 79, wherein at the closed position said skirt segment 79 extends behind and below the back portion of the top edge 34 of base container 22.

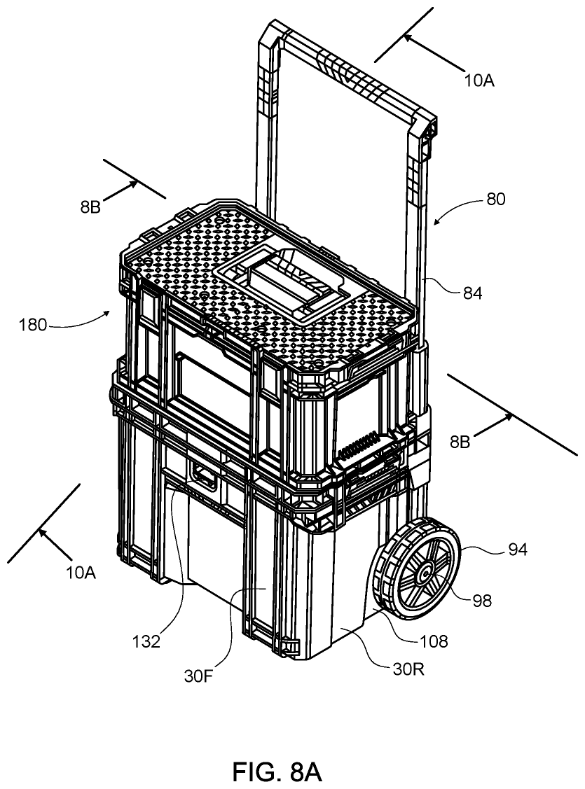

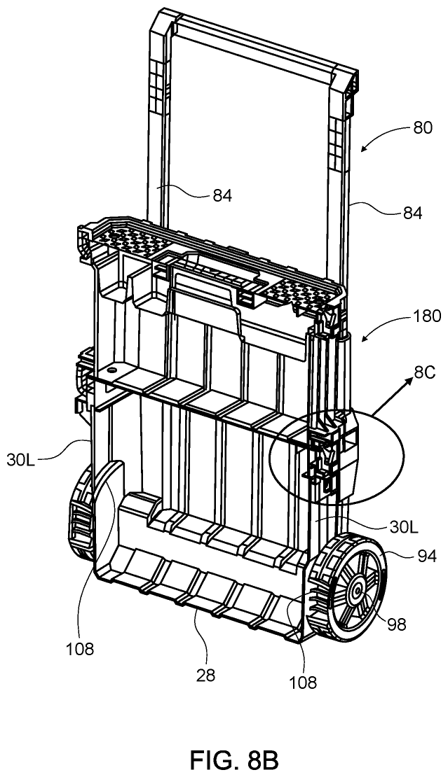

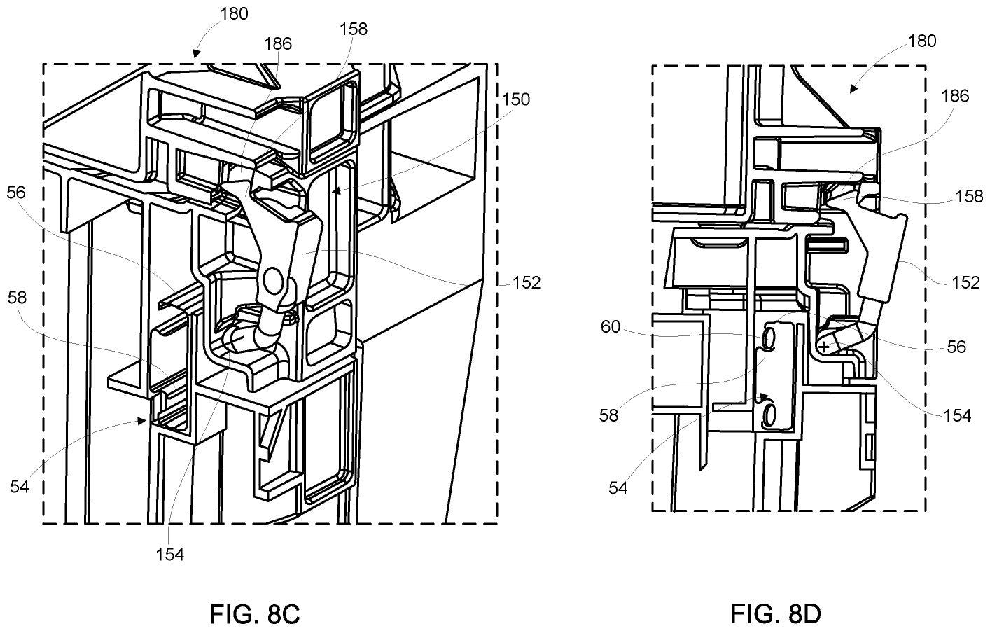

A back portion of the slidable lid 50 is configured with a handle assembly generally designated 80, comprising a grip handle 82 extending between a pair of telescopically retractable leg members 84 and a retraction/collapsing lock mechanism at 88 facilitating length adjustment of the telescopic leg members 84 between a fully retracted position (e.g. FIGS. 6A-6C, 8A and 8B), and fully collapsed position (e.g. FIGS. 1A-2A), with intermediate positions available too.

A locomotive arrangement 85 is articulated at a bottom portion of the handle assembly 80, said locomotive arrangement 85 comprising a pair of wheels 94, each articulated by axle 98 to an axle support member 102 (best seen in FIGS. 6B and 7B), said axle support member 102 inwardly extending from a non-displaceable bottom support segment 99 of the telescopic handle, whereby elevation of the axle 98 and wheels 94 is fixed, with a bottom wheel tangent extending substantially co-leveled (at 101; FIGS. 1C and 6B) with bottom surface of base wall 28 of base container 22.

According to a particular design, when the slidable lid 50 with the handle assembly and the locomotive arrangement, is at the closed position, an inside face portion of the wheels 94 is received within wheel receiving depressions 108 formed at the side walls 30R and 30L, respectively (said depression seen best in FIGS. 6A and 6B).

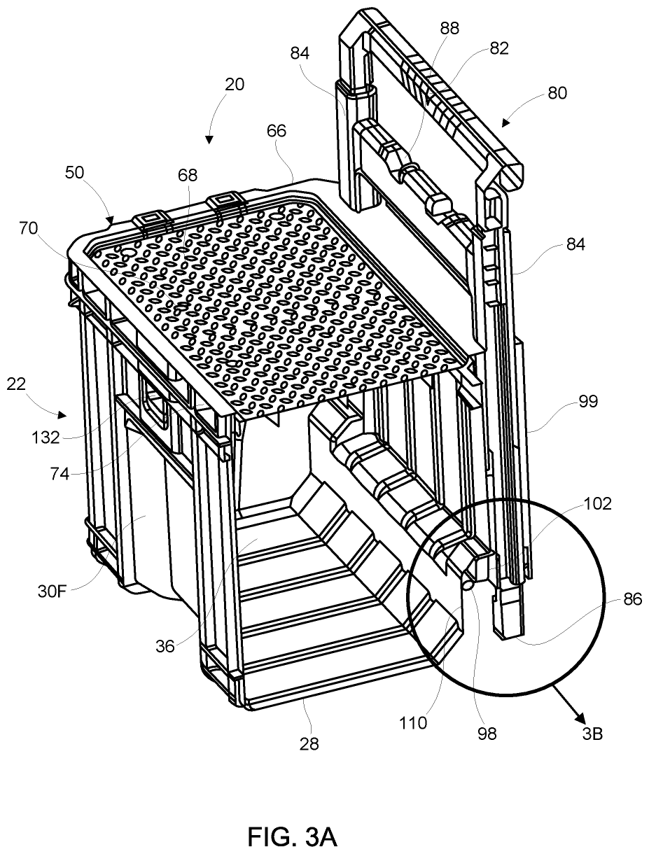

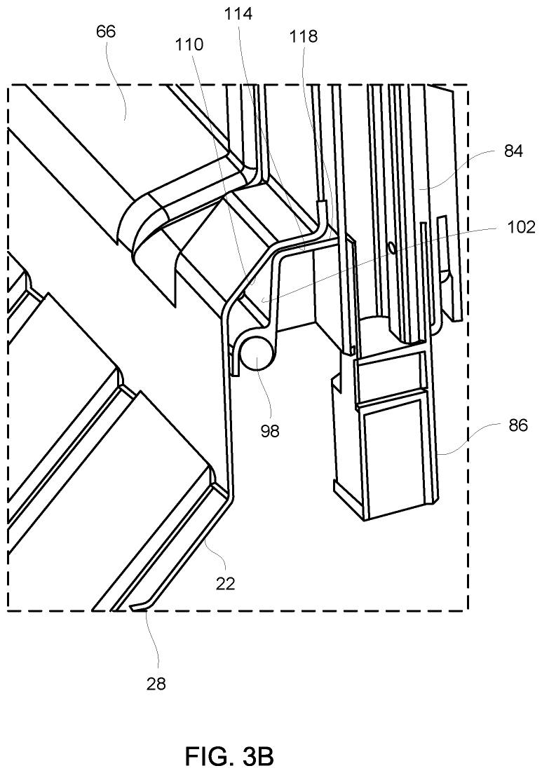

As can further be seen, best in FIGS. 3A and 3B, at the closed position, the inwardly extending axle support members 102 is received within a wheel axle support indention 110 formed at a rear face 30B of the base container 22, and wherein a bottom face portion 114 of the wheel axle support indention 110 of the base container, bears over a top face 118 of said axle support members 102, whereby loads of the base container 22 and any optional utility modules mounted thereover are directed through the axle support members 102 to the wheels 94, rather than extending through the back portion of the slidable lid and the handle assembly.

Likewise, it is seen that at the fully collapsed position of the handle assembly 80, a bottom end 86 of the telescopic leg members 84 extends before axle 98 and slightly behind rear wheel tangent T (FIG. 1C), and slightly above the bottom surface 28 of base container 22 and ground level 101.

The arrangement is such that the container assembly 20 can be rolled over the wheels 94 of the locomotive assembly 85, by slightly tilting the entire container assembly 20 backwards (in direction of arrow 120 in FIG. 1C), whereby the wheels 94 remain engaged with the ground surface 101, and however where the base container 22 disengages from the ground surface.

As can be further seen, the container assembly 20 further comprises a lid locking mechanism 130 (best appreciated in FIG. 2B), for arresting the slidable lid 50 and preventing spontaneous sliding displacement at least when at the closed position. Accordingly, there is a spring-loaded locking latch 132 extending at the front face 30F of the base container 22, and biased to project from the top edge 76 of the base container 22. The locking latch 132 is configured for spontaneously arresting within a recess 134 configured at a bottom face of the front edge of the slidable lid 50, when the latter is displaced into its closed position. Locking latch 132 has a chamfered portion 138 for momentarily displacing latch 132 into an open position when the slidable lid is displaced into its closed position. Opening the lid locking mechanism 130 takes place by manipulating the locking latch 132 downwards, against the spring biasing effect, using a finger/s inserted into finger manipulating opening 140.

It is however appreciated that the lid locking mechanism can assume other configurations, such as, any one or more of side locking latches, back locking latch, rotary locking latch, snap locking latch, manually operable locking latches, etc.

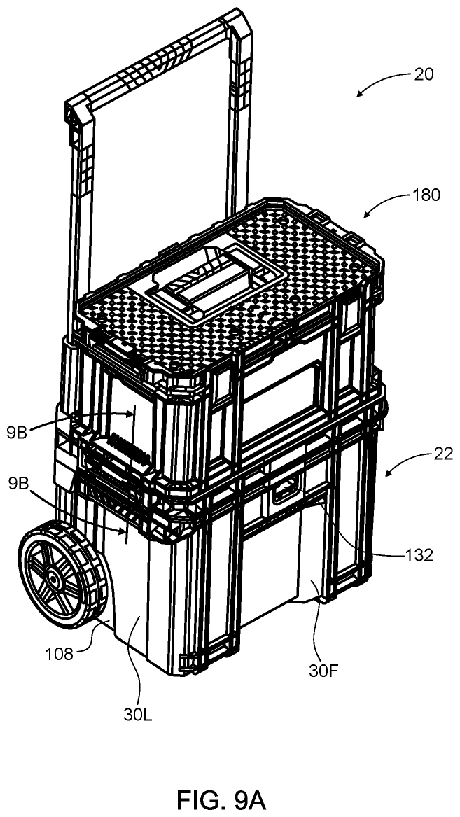

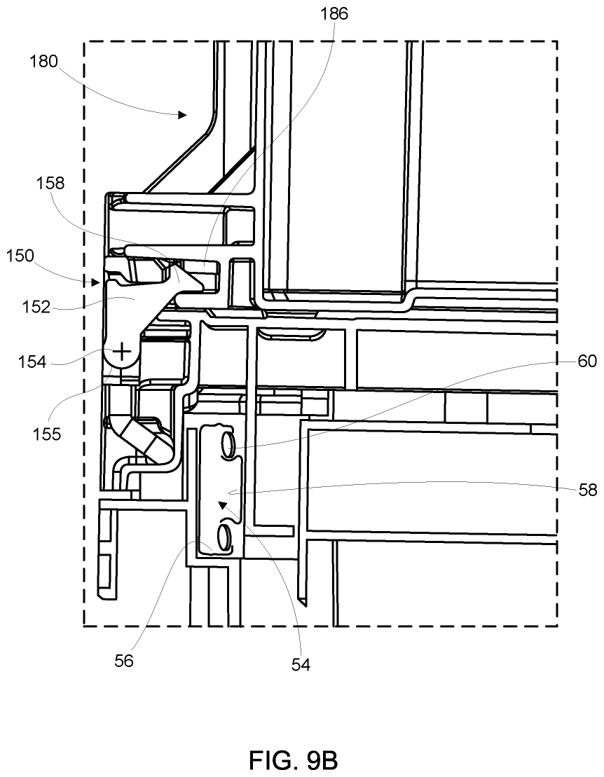

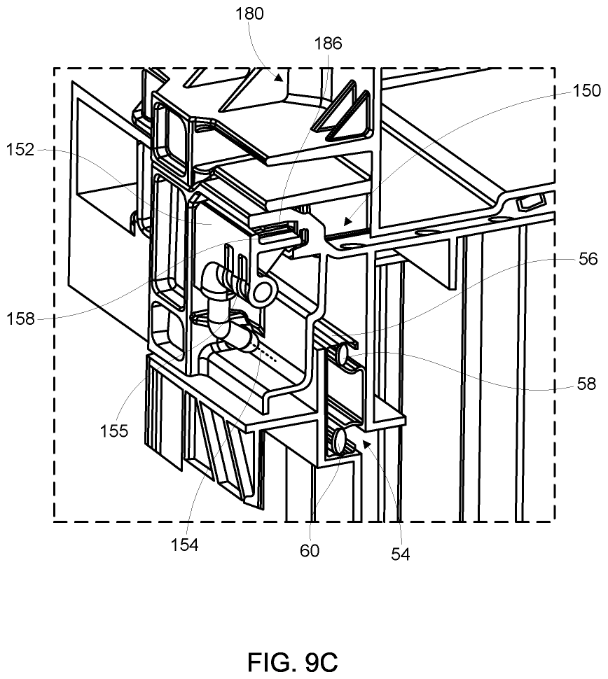

The slidable lid 50 is configured with an articulation arrangement for detachably articulating thereto at least one utility module. A first example is illustrated in FIGS. 1A to 11B, and is disclosed in U.S. Pat. No. 10,793,17 incorporated herein by reference. The articulation arrangement 150 comprises a pair of locking members 152, each at a respective top side edge of the lid 50, said locking members 152 are each pivotally secured and displaceable about a pivot axis 154 (below the top rim 66) and are configured with a pair of inward facing locking members 158. The locking members 158 are pivotally displaceable between an open position (FIGS. 4A to 4D) and a closed position (FIGS. 5A to 5E). At the open position the locking members 152 are outwardly pivoted, with the locking members 158 out of engagement from arresting windows 160 within the top rim 66. At the closed position the locking members 152 are inwardly pivoted, with the locking members 158 disposed within the arresting windows 160 and at a position configurable for arresting within a locking receptacles 186 of a utility module 180.

The arrangement is such that when a utility module 180 is placed at utility module receiving portion 68, the locking members 152 can be displaced into arresting within the locking receptacles 186, thereby locking the utility module 180 in position, over the slidable lid 50.

The container assembly can be easily locomoted over wheels 94, and when desired the lid 50 can be displaced into the open position (FIGS. 11A and 11B) for exposing the inside space 36 of the base container 22, simply by positioning the assembly 20 at an upright position, momentarily unlocking the locking latch 132 and slidingly displacing lid 50 into its open position, with the handle assembly 80 and locomotive arrangement 85 displacing along with the lid 50, however with the base container 22 remaining steady in place. Closing the lid 50 takes place by simply sliding displacing the lid 50 with the handle assembly 80 and locomotive arrangement 85 into closing, allowing the locking latch 132 to snap engage with the recess 134. Closing too, takes place without movement of the base container 22.

The locking members 152 are configured with a gripping portion 155 useful for lifting the container assembly 20.

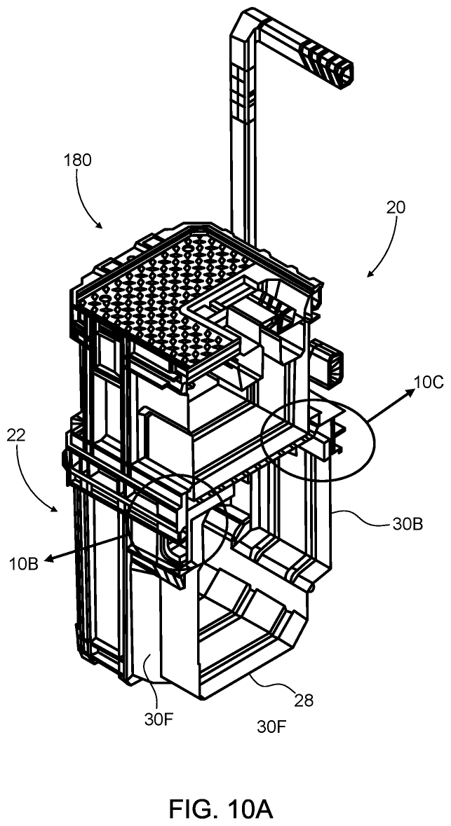

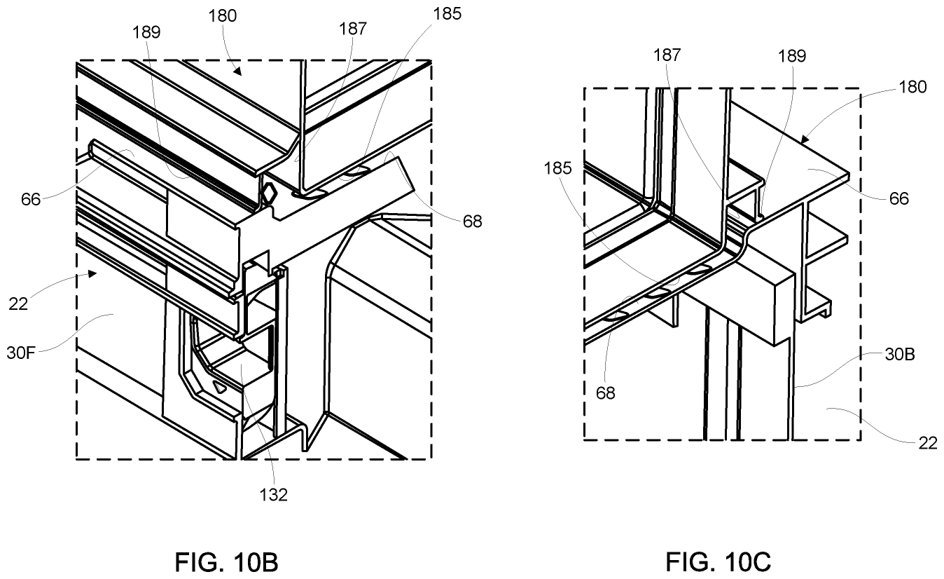

Regardless of the utility module articulation arrangement, when the utility module 180 is in position over the slidable lid 50 (FIGS. 10B and 10C) a bottom 185 surface of the utility module 180 can rest over the utility module receiving portion 68 of the lid 50, or it can extend slightly spaced apart, at seen in the drawings, and wherein a downward facing peripheral skirt 189 of utility module 180 rests over the annular rim 66 of the lid 50, and however wherein a bottom base portion of utility module 180 is received within the utility module receiving portion 68 of the lid 50.

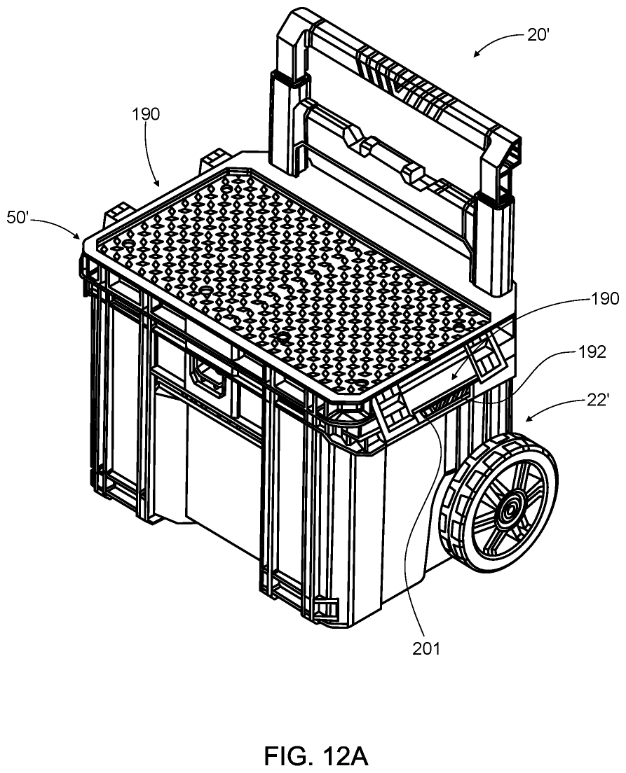

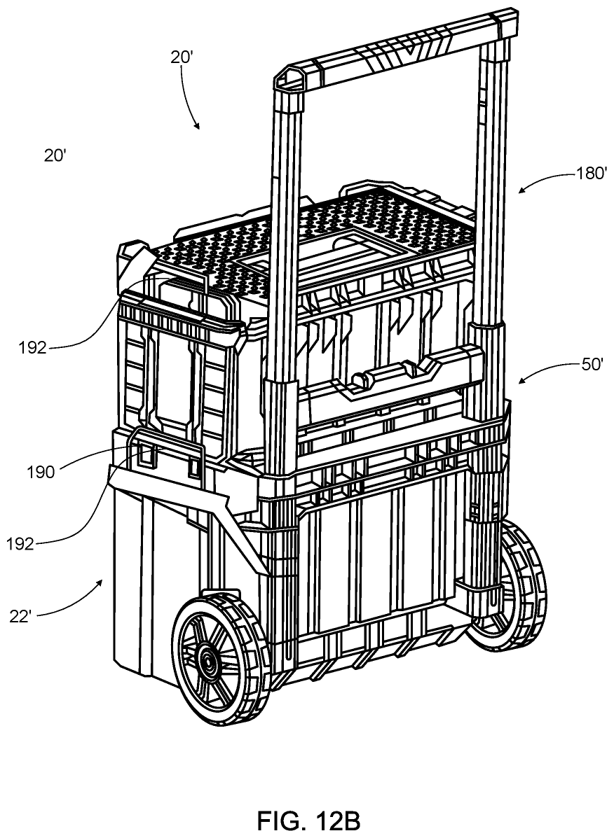

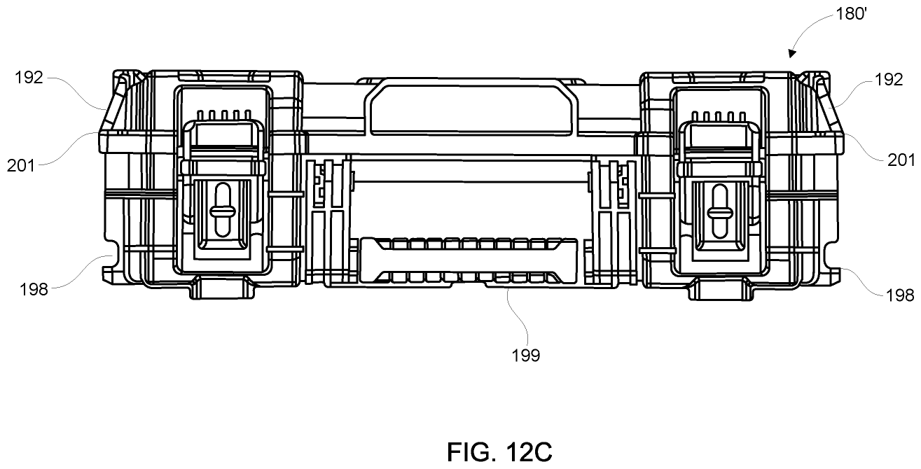

Yet an example of an articulation arrangement for detachably articulating thereto at least one utility module is illustrated in FIGS. 12A to 12C, and is disclosed in U.S. Pat. No. 11,230,410 incorporated herein by reference.

FIGS. 12A to 12C disclose a container assembly 20′ substantially similar with the container assembly 20 of the previous FIGS. Wherein like elements are designated with like reference numbers with a (′) indication. The articulation arrangement 190 disclosed in FIGS. 12A to 12C comprises a pair of pivoting latch members 192, each disposed at an opposite side of the slidable lid 50′, and the utility module 180′ is configured at a bottom portion thereof with a pair of spaced apart locking retaining members 198, configured for detachable articulation with the pivoting latch members 192 of the slidable lid; wherein the slidable lid 50′ is configured with a top bearing face (module receiving portion 68′) and said utility module 180′ is configured with a bottom bearing face 199, whereby the pivoting latch members 192 can be arrested by the locking retaining members 198 when the bottom bearing face bears over the top bearing face.

In the example of FIGS. 12A to 12C the locking retaining members 198 are configured with a handle like gripping portion 201, useful for lifting the container assembly 20′.

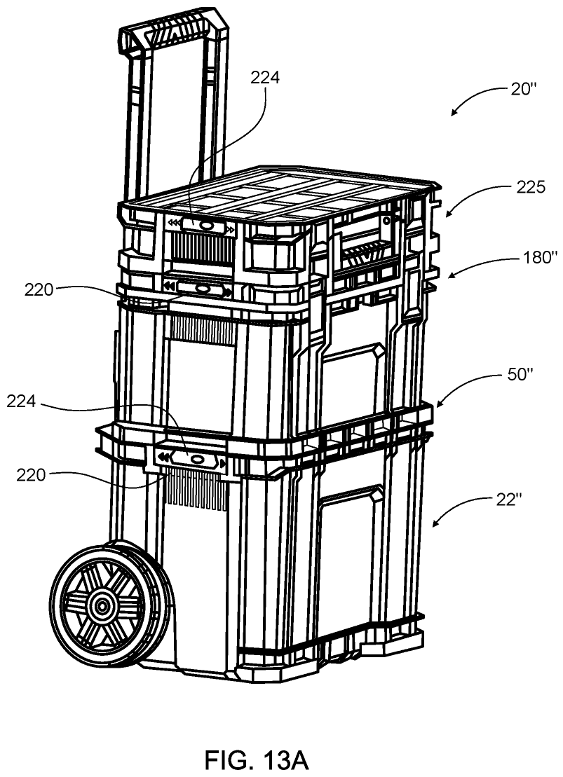

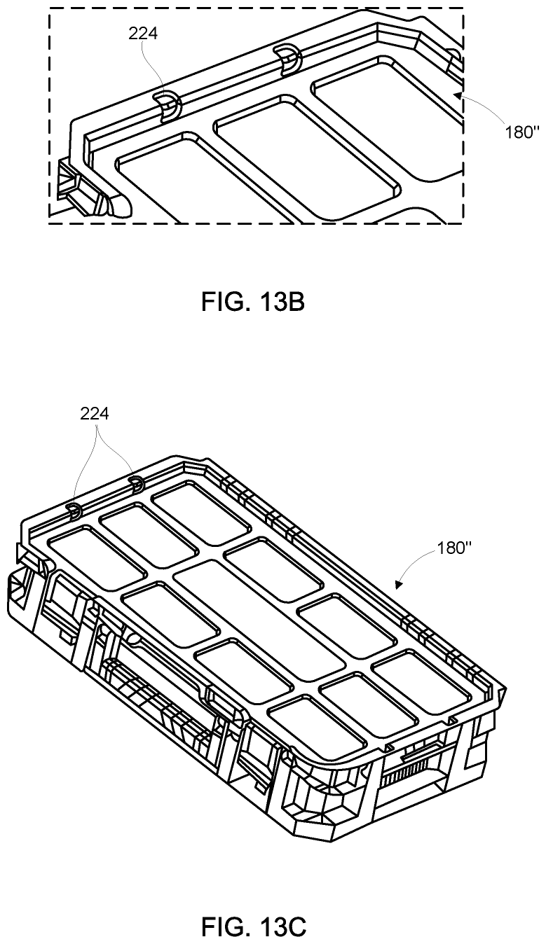

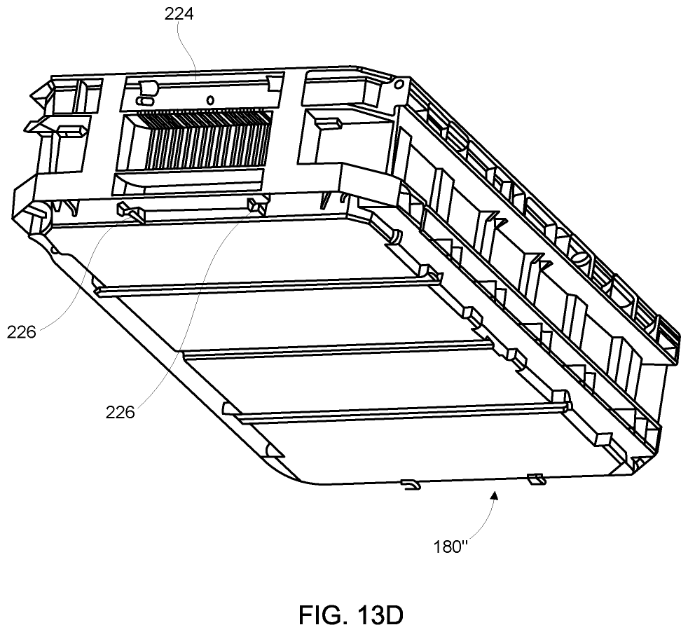

Another example of an articulation arrangement for detachably articulating thereto at least one utility module is illustrated in FIGS. 13A to 13D, and is disclosed in said US10,793,17 incorporated herein by reference.

FIGS. 13A to 13D disclose a container assembly 20″ substantially similar with the container assembly 20 of the previous FIGS. Wherein like elements are designated with like reference numbers with a (″) indication.

The container assembly 20″ comprises a base container 22″, a first utility module (being a container) 180″ articulated thereover, and a second utility module (a container too) 225.

The articulation arrangement 220 comprises a sliding locking mechanism, wherein the slidable lid 50″ is configured with a first locking member 224 and the utility module 180″ is configured at a bottom portion thereof with a second locking member 226; such that when the utility module 180″ rests over the slidable lid 50″, said first locking member 224 and said second locking members 226 are aligned and are configured for lockingly interacting with one another by sliding displacement the first locking member 224.

It is appreciated that a slidable lid according to the disclosure can be configured with an articulation arrangement fitted for detachably attaching thereto a utility module having a smaller footprint than that of the slidable lid. For that purpose, various articulation arrangements can be disposed over the top face and/or rim of the lid.

1. A transportable container assembly comprising a base container configured with upright extending side walls defining a top opening of the base container, a slidable lid is slidingly displaceable over the top opening of the base container between a closed position wherein the lid coextends over and covers the top opening, and an open position wherein the lid is displaced backwards and exposes the base container to allow access thereto; wherein the slidable lid is configured with an articulation arrangement for detachably articulating thereto at least one utility module, and wherein a back portion of the lid is configured with a handle assembly and a locomotive arrangement for locomoting the container assembly at the closed position, wherein the handle assembly is a telescopic handle manipulable between a collapsed position and at least one retracted position, and the locomotive arrangement is a wheel assembly disposed at a bottom portion of the handle assembly, and wherein the container assembly is locomoted over the wheel assembly by tilting the container assembly backwards.

2. (canceled)

3. The transportable container assembly according to claim 1, wherein the wheel assembly comprises at least a pair of wheels wherein a tangent of the wheels is leveled with a bottom face of the base container.

4. The transportable container assembly according to claim 1, wherein the wheels are disposed at a fixed elevation, and wherein when the container assembly is positioned over a flat support surface, displacing the slidable lid into its open position entails rolling displacement of the wheels over a ground surface.

5. The transportable container assembly according to claim 1, wherein a roll axis of the wheels extends (i) below bottom ends of legs of the handle assembly, or (ii) between a back face of the base container and the front face of the handle assembly.

6. (canceled)

7. The transportable container assembly according to claim 21, wherein an axle of the wheels is articulable to an axle support member inwardly extending from a bottom portion of legs of the telescopic handle.

8. The transportable container assembly according to claim 7, wherein the wheels axle is supported by two support members, each extending at a bottom of a respective leg of the handle assembly.

9. The transportable container assembly according to claim 21, wherein an axle of the wheels is articulable to a non-displaceable bottom support segment of the handle assembly, thereby retaining the wheels at a fixed elevation.

10. (canceled)

11. (canceled)

12. (canceled)

13. The transportable container assembly according to claim 21, wherein at the closed position of the slidable lid, a bottom face portion of the wheel axle support indention of the base container bears over a top face of said axle support members.

14. (canceled)

15. (canceled)

16. (canceled)

17. The transportable container assembly according to claim 1, wherein the slidable lid is configured at a back end thereof with a downwardly extending portion, wherein at the closed position of the slidable lid a front face of said downwardly extending portion extends behind a rear face of a rear top edge of the base container.

18. (canceled)

19. The transportable container assembly according to claim 21, wherein at the fully closed position of the slidable lid, a portion of the wheels is received within depressions configured at respective side walls of the base container.

20.-27. (canceled)

28. The transportable container assembly according to claim 1, wherein the utility module is detachably attachable over the top face of the slidable lid, regardless of the position of the slidable lid and/or of the telescopic handle.

29. (canceled)

30. (canceled)

31. The transportable container assembly according to claim 1, wherein the slidable lid is slidably articulated over the base container by a rail mechanism disposed at respective side ends of the base container and slidable lid, wherein the rail mechanism is a telescopic rail set, comprising a first rail member articulated at a top portion of the base container, and a second rail member articulated at a bottom portion of the slidable lid, wherein the first rail member and the second rail member are engaged with one another and configured for sliding displacement with respect to one another.

32. (canceled)

33. The transportable container assembly according to claim 31, wherein the first rail member and the second rail member are configured for reduced sliding friction therebetween.

34. The transportable container assembly according to claim 31, wherein the first rail member is secured at an inside top side edges of the base container, and the second rail member is configured at an outside-facing wall portion of the slidable lid, respectively.

35. The transportable container assembly according to claim 1, wherein either or both of the base container and the slidable lid comprise a sliding restricting arrangement, configured for restricted sliding displacement of the sliding lid between a fully open position and a closed position thereof.

36. (canceled)

37. The transportable container assembly according to claim 1, wherein the articulation arrangement is configured at a top face of the slidable lid.

38. The transportable container assembly according to claim 1, wherein the articulation arrangement is configured at any location of the of the slidable lid.

39. The transportable container assembly according to claim 1, wherein the articulation arrangement is configured at either or both side portions of the slidable lid, and/or the articulation arrangement can be disposed at either or both back and front portions of the slidable lid.

40. The transportable container assembly according to claim 1, wherein the articulation arrangement is configured for attaching a utility module having a smaller footprint than that of the lid assembly.

41. The transportable container assembly according to claim 1, wherein the articulation arrangement comprises at least one locking member pivotally secured to the lid assembly, and the utility module is configured with a locking receptacle; wherein the locking member is configured with at least one locking latch configurable for locking engagement within said locking receptacle; and wherein the locking member is pivotally displaceable between a locked position in which the at least one locking latch is radially engaged within the locking receptacle, and an unlocked position in which the locking member is outwardly pivoted and the at least one locking latch is disengaged from the locking receptacle.

42. The transportable container assembly according to claim 1, wherein the articulation arrangement comprises a sliding locking mechanism, wherein the lid assembly is configured with a first locking member and the utility module is configured at a bottom portion thereof with a second locking member; such that when the utility module rests over the lid assembly, said first locking member and said second locking members are aligned and are configured for lockingly interacting with one another.

43. The transportable container assembly according to claim 1, wherein the articulation arrangement comprises a pair of pivoting latch members, each disposed near an opposite end of the lid assembly, and the utility module is configured at a bottom portion thereof with a pair of spaced apart locking retaining members for detachable articulation with the pivoting latch members of the slidable lid; wherein the slidable lid is configured with a top bearing face and said utility module is configured with a bottom bearing face, whereby the pivoting latch members can be arrested by the locking retaining members when the bottom bearing face bears over the top bearing face.
